(19) United States
(12) Patent Application Publication
(10) Pub. No.: US 2023/0154494 A1
(43) Pub. Date: May 18, 2023

(54) MAGNETIC TAPE CARTRIDGE, MAGNETIC TAPE DRIVE, MAGNETIC TAPE SYSTEM, AND METHOD OF OPERATING MAGNETIC TAPE DRIVE

(71) Applicant: FUJIFILM Corporation, Tokyo (JP)

(72) Inventors: Toru NAKAO, Kanagawa (JP); Norihito KASADA, Kanagawa (JP); Tetsuya KANEKO, Kanagawa (JP); Atsushi MUSHA, Kanagawa (JP)

(73) Assignee: FUJIFILM Corporation, Tokyo (JP)

(21) Appl. No.: 18/158,048

(22) Filed: Jan. 23, 2023

Related U.S. Application Data
(63) Continuation of application No. PCT/JP21/20493, filed on May 28, 2021.

(30) Foreign Application Priority Data
Jul. 30, 2020 (JP) 2020-129563

(51) Int. Cl. G11B 15/43

(52) U.S. Cl. CPC G11B 15/43

(57) ABSTRACT

Provided is a magnetic tape cartridge including: a case in which a magnetic tape is accommodated; and a storage medium provided in the case, in which the storage medium stores tension allowable range related information regarding an allowable range of tension applied to the magnetic tape.

### CROSS-REFERENCE TO RELATED APPLICATIONS

This application is a continuation application of International Application No. PCT/JP2021/020493 filed on May 28, 2021, the disclosure of which is incorporated herein by reference in its entirety. Further, this application claims priority from Japanese Patent Application No. 2020-129563 filed on Jul. 30, 2020, the disclosure of which is incorporated herein by reference in its entirety.

### BACKGROUND

### 1. Technical Field

The technology of the present disclosure relates to a magnetic tape cartridge, a magnetic tape drive, a magnetic tape system, and a method of operating a magnetic tape drive.

### 2. Description of the Related Art

A cartridge memory that stores information is mounted in a magnetic tape cartridge in which a magnetic tape is accommodated. JP6669326B discloses that information at a time of data recording in a magnetic tape drive is stored in a cartridge memory and the information is read out from the cartridge memory at a time of data reading for reference. The information includes information on tension applied to a running magnetic tape at the time of data recording.

### SUMMARY

Many types of magnetic tapes have been released from each manufacturer, and each of a plurality of types of magnetic tapes has a tension allowable range. There is a concern that irreversible damage, such as plastic deformation, may be given to the magnetic tape in a case where tension exceeding an upper limit value of the allowable range is applied to the magnetic tape. On the other hand, there is a concern that the running magnetic tape may be flapped in a case where tension below a lower limit value of the allowable range is applied to the magnetic tape.

An embodiment according to the technology of the present disclosure provides a magnetic tape cartridge, a magnetic tape drive, a magnetic tape system, and a method of operating a magnetic tape drive capable of obtaining information regarding an allowable range of tension applied to a magnetic tape.

According to the present disclosure, there is provided a magnetic tape cartridge comprising: a case in which a magnetic tape is accommodated; and a storage medium provided in the case, in which the storage medium stores tension allowable range related information regarding an allowable range of tension applied to the magnetic tape.

It is preferable that the tension allowable range related information is identification information corresponding to any one of upper and lower limit values of the allowable range or a pair of a median value of the allowable range and a difference of the upper and lower limit values of the allowable range with respect to the median value.

It is preferable that the tension allowable range related information is any one of upper and lower limit values of the allowable range or a pair of a median value of the allowable range and a difference of the upper and lower limit values of the allowable range with respect to the median value.

It is preferable that the storage medium includes an internal storage medium incorporated in a noncontact communication medium where reading-out and writing-in of information are performed by a noncontact reading and writing device.

It is preferable that the tension allowable range related information is stored in a storage block in which information is unrewritable, the storage block being provided in the internal storage medium.

It is preferable that the storage medium includes a region of a part of the magnetic tape.

According to the present disclosure, there is provided a magnetic tape drive in which the magnetic tape cartridge according to any one of the above is loaded, the magnetic tape drive comprising: a tension applying mechanism; and a processor that controls an operation of the tension applying mechanism to apply tension within the allowable range represented by the tension allowable range related information to the magnetic tape.

According to the present disclosure, there is provided a method of operating a magnetic tape drive, comprising: reading out the tension allowable range related information stored in the storage medium provided in the magnetic tape cartridge according to any one of the above; and controlling an operation of a tension applying mechanism to apply tension within the allowable range represented by the read-out tension allowable range related information to the magnetic tape.

According to the present disclosure, there is provided a magnetic tape system comprising: the magnetic tape cartridge according to any one of the above; a read-out device that reads out the tension allowable range related information stored in the storage medium; and a control device that controls an operation of a tension applying mechanism to apply tension within the allowable range represented by the read-out tension allowable range related information to the magnetic tape.

According to the technology of the present disclosure, it is possible to provide a magnetic tape cartridge, a magnetic tape drive, a magnetic tape system, and a method of operating a magnetic tape drive capable of obtaining information regarding an allowable range of tension applied to a magnetic tape.

### BRIEF DESCRIPTION OF THE DRAWINGS

Exemplary embodiments according to the technique of the present disclosure will be described in detail based on the following figures, wherein:

FIG. 1 is a schematic perspective view showing an example of an external appearance of a magnetic tape cartridge;

FIG. 2 is a schematic perspective view showing an example of a structure of a rear right end part inside a lower case of the magnetic tape cartridge;

FIG. 3 is a side cross-sectional view showing an example of a support member provided on an inner surface of the lower case of the magnetic tape cartridge;

FIG. 4 is a schematic configuration diagram showing an example of a hardware configuration of a magnetic tape drive;

FIG. 5 is a schematic perspective view showing an example of an aspect in which a magnetic field is emitted by a noncontact reading and writing device from a lower side of the magnetic tape cartridge;

FIG. 6 is a conceptual diagram showing an example of an aspect in which a magnetic field is applied from the noncontact reading and writing device to a cartridge memory provided in the magnetic tape cartridge;

FIG. 7 is a schematic bottom view showing an example of a structure of a back surface of a substrate of the cartridge memory provided in the magnetic tape cartridge;

FIG. 8 is a schematic plan view showing an example of a structure of a front surface of the substrate of the cartridge memory provided in the magnetic tape cartridge;

FIG. 9 is a schematic circuit diagram showing an example of a circuit configuration of the cartridge memory provided in the magnetic tape cartridge;

FIG. 10 is a block diagram showing an example of a hardware configuration of a computer of an IC chip mounted in the cartridge memory provided in the magnetic tape cartridge;

FIG. 11 is a diagram showing an example of a storage block in which tension allowable range related information is stored;

FIG. 12 is a diagram showing an example of an aspect in which the tension allowable range related information is written into the storage block;

FIG. 13 is a diagram showing an example of an aspect in which locking processing is performed on the storage block in which the tension allowable range related information is stored;

FIG. 14 is a block diagram showing an example of a detailed configuration of a control device;

FIG. 15 is a diagram showing an example of an aspect in which the tension allowable range related information is read out from the storage block and tension within the allowable range represented by the read-out tension allowable range related information is applied to the magnetic tape;

FIG. 16 is a flowchart showing an example of an operation procedure of a CPU of the cartridge memory;

FIG. 17 is a flowchart showing an example of an operation procedure of the magnetic tape drive;

FIG. 18 is a diagram showing another example of an allowable range table;

FIG. 19 is a diagram showing another example of the tension allowable range related information;

FIG. 20 is a diagram showing still another example of the tension allowable range related information;

FIG. 21 is a diagram showing an example of an aspect in which the tension allowable range related information is written into a BOT region of the magnetic tape; and

FIG. 22 is a diagram showing another example of the aspect in which the tension allowable range related information is written into the BOT region of the magnetic tape.

### DETAILED DESCRIPTION

Hereinafter, an example of an embodiment of a magnetic tape cartridge and a magnetic tape drive according to the technology of the present disclosure will be described with reference to the accompanying drawings.

First, terms that are used in the following description will be described.

CPU is an abbreviation for “Central Processing Unit”. RAM is an abbreviation for “Random Access Memory”. NVM is an abbreviation for “Non-Volatile Memory”. ROM is an abbreviation for “Read Only Memory”. EEPROM is an abbreviation for “Electrically Erasable and Programmable Read Only Memory”. ASIC is an abbreviation for “Application Specific Integrated Circuit”. PLD is an abbreviation for “Programmable Logic Device”. FPGA is an abbreviation for “Field-Programmable Gate Array”. SoC is an abbreviation for “System-on-a-Chip”. IC is an abbreviation for “Integrated Circuit”. RFID is an abbreviation for “Radio Frequency IDentifier”. LTO is an abbreviation for “Linear Tape-Open”. IBM is an abbreviation for “International Business Machines Corporation”. CM is an abbreviation for “Cartridge Memory”. ID is an abbreviation for “Identification Data”. BOT is an abbreviation for “Beginning Of Tape”. EOT is an abbreviation for “End Of Tape”. ISO is an abbreviation for “International Organization for Standardization”. ECMA is an abbreviation for “European Computer Manufacturers Association”.

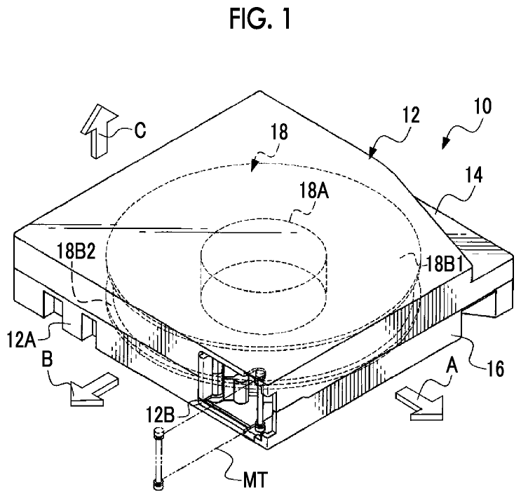

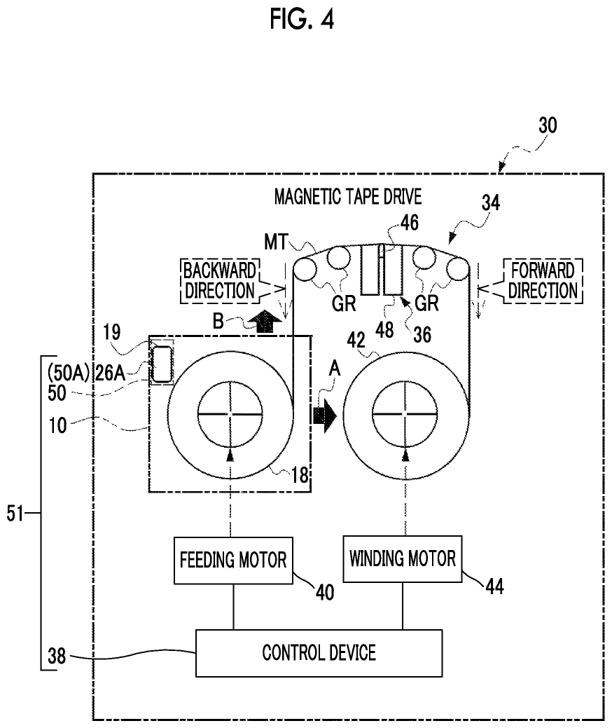

In the following description, for convenience of description, in FIG. 1, a loading direction of a magnetic tape cartridge 10 into a magnetic tape drive 30 (see FIG. 4) is indicated by an arrow A, a direction of the arrow A is referred to as a front direction of the magnetic tape cartridge 10, and a side in the front direction of the magnetic tape cartridge 10 is referred to as a front side of the magnetic tape cartridge 10. In the following description of the structure, “front” indicates the front side of the magnetic tape cartridge 10.

Further, in the following description, for convenience of description, in FIG. 1, a direction of an arrow B perpendicular to the direction of the arrow A is referred to as a right direction, and a side in the right direction of the magnetic tape cartridge 10 is referred to as a right side of the magnetic tape cartridge 10. In the following description of the structure, “right” indicates the right side of the magnetic tape cartridge 10.

Further, in the following description, for convenience of description, in FIG. 1, a direction perpendicular to the direction of the arrow A and the direction of the arrow B is indicated by an arrow C, a direction of the arrow C is referred to as an upper direction of the magnetic tape cartridge 10, and a side in the upper direction of the magnetic tape cartridge 10 is referred to as an upper side of the magnetic tape cartridge 10. In the following description of the structure, “upper” indicates the upper side of the magnetic tape cartridge 10.

Further, in the following description, for convenience of description, in FIG. 1, a direction opposite to the front direction of the magnetic tape cartridge 10 is referred to as a rear direction of the magnetic tape cartridge 10, and a side in the rear direction of the magnetic tape cartridge 10 is referred to as a rear side of the magnetic tape cartridge 10. In the following description of the structure, “rear” indicates the rear side of the magnetic tape cartridge 10.

Further, in the following description, for convenience of description, in FIG. 1, a direction opposite to the right direction of the magnetic tape cartridge 10 is referred to as a left direction of the magnetic tape cartridge 10, and a side in the left direction of the magnetic tape cartridge 10 is referred to as a left side of the magnetic tape cartridge 10. In the following description of the structure, “left” indicates the left side of the magnetic tape cartridge 10.

Further, in the following description, for convenience of description, in FIG. 1, a direction opposite to the upper direction of the magnetic tape cartridge 10 is referred to as a lower direction of the magnetic tape cartridge 10, and a side in the lower direction of the magnetic tape cartridge 10 is referred to as a lower side of the magnetic tape cartridge 10. In the following description of the structure, “lower” indicates the lower side of the magnetic tape cartridge 10.

Further, in the following description, although LTO will be described as an example of the specification of the magnetic tape cartridge 10, this is merely an example, and the specification of the magnetic tape cartridge 10 may conform to the specification of IBM3592 or the like.

### First Embodiment

As shown in FIG. 1 as an example, the magnetic tape cartridge 10 has a substantially rectangular shape in a plan view, and comprises a box-shaped case 12. The case 12 is formed of a resin, such as polycarbonate, and comprises an upper case 14 and a lower case 16. The upper case 14 and the lower case 16 are bonded to each other by welding (for example, ultrasonic welding) and screwing in a state in which a lower peripheral edge surface of the upper case 14 and an upper peripheral edge surface of the lower case 16 are brought into contact with each other. The bonding method is not limited to the welding and the screwing, and other bonding methods may be used.

A cartridge reel 18 is rotatably accommodated inside the case 12. The cartridge reel 18 comprises a reel hub 18A, an upper flange 18B1, and a lower flange 18B2. The reel hub 18A is formed in a cylindrical shape. The reel hub 18A is a shaft center portion of the cartridge reel 18, has a shaft center direction along an up-down direction of the case 12, and is disposed in a central portion of the case 12. Each of the upper flange 18B1 and the lower flange 18B2 is formed in an annular shape. A central portion in a plan view of the upper flange 18B1 is fixed to an upper end part of the reel hub 18A, and a central portion in a plan view of the lower flange 18B2 is fixed to a lower end part of the reel hub 18A. A magnetic tape MT is wound around an outer peripheral surface of the reel hub 18A, and widthwise end parts of the magnetic tape MT are held by the upper flange 18B1 and the lower flange 18B2. The reel hub 18A and the upper flange 18B1 and/or the lower flange 18B2 may be integrally molded.

An opening 12B is formed on a front side of a right wall 12A of the case 12. The magnetic tape MT is pulled out from the opening 12B.

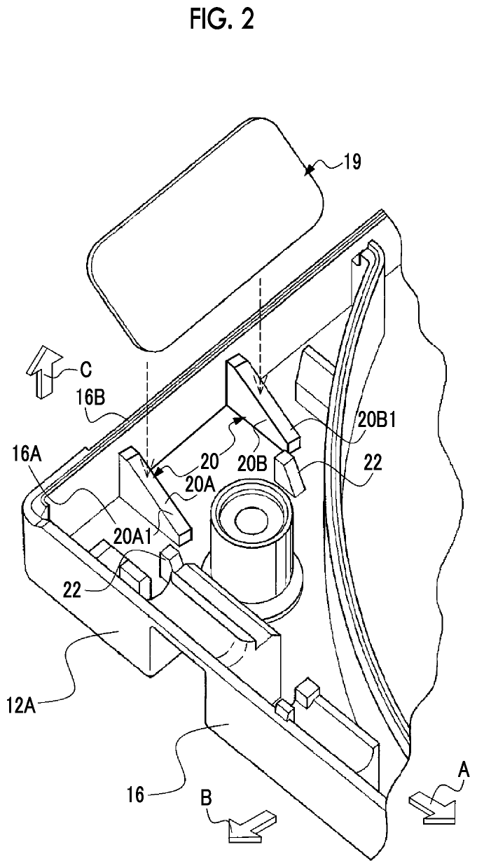

As shown in FIG. 2 as an example, a cartridge memory 19 is accommodated in a rear right end part of the lower case 16. The cartridge memory 19 is an example of a “noncontact communication medium” according to the technology of the present disclosure. In the present embodiment, a so-called passive type RFID tag is employed as the cartridge memory 19.

Information regarding the magnetic tape MT is stored in the cartridge memory 19. The information regarding the magnetic tape MT indicates, for example, management information for managing the magnetic tape cartridge 10. Examples of the management information include information regarding the cartridge memory 19, information capable of specifying the magnetic tape cartridge 10, information indicating a recording capacity of the magnetic tape MT, the outline of data recorded on the magnetic tape MT, items of data, a recording format of data, and the like.

The cartridge memory 19 performs noncontact communication with a noncontact reading and writing device. Examples of the noncontact reading and writing device include a noncontact reading and writing device (for example, a noncontact reading and writing device 50B shown in FIG. 12) that is used in a production process of the magnetic tape cartridge 10 and a noncontact reading and writing device (for example, a noncontact reading and writing device 50A shown in FIGS. 4 to 6, and 15) that is used in the magnetic tape drive (for example, the magnetic tape drive 30 shown in FIG. 4).

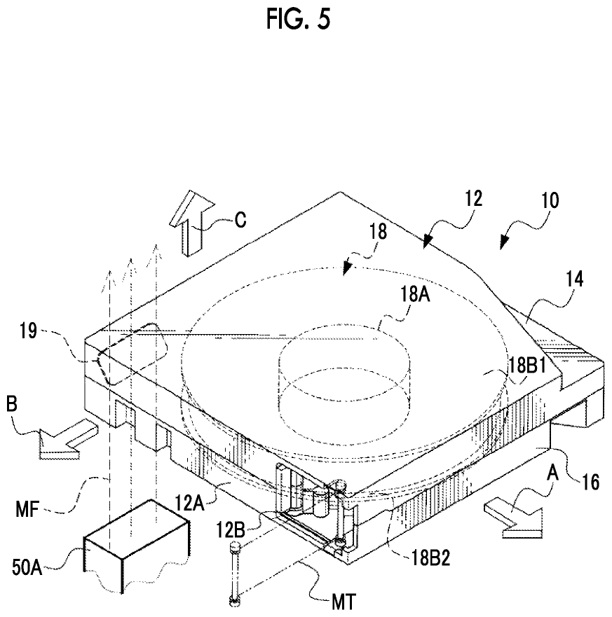

The noncontact reading and writing device performs reading and writing of various types of information with respect to the cartridge memory 19 in a noncontact manner. Although details will be described later, the cartridge memory 19 generates power with electromagnetic application of a magnetic field MF (see FIG. 5 and the like) from the noncontact reading and writing device. Then, the cartridge memory 19 operates using the generated power, and transmits and receives various types of information to and from the noncontact reading and writing device by performing communication with the noncontact reading and writing device via the magnetic field MF. As the communication method between the noncontact reading and writing device and the cartridge memory 19, for example, a method conforming to a known standard, such as ISO14443 or ISO18092, can be employed. Alternatively, a method conforming to the specification of the LTO, such as ECMA319, can be employed.

As shown in FIG. 2 as an example, a support member 20 is provided on an inner surface of a bottom plate 16A of the rear right end part of the lower case 16. The support member 20 is a pair of inclined mounts that support the cartridge memory 19 from below in an inclined state. The pair of inclined mounts are a first inclined mount 20A and a second inclined mount 20B. The first inclined mount 20A and the second inclined mount 20B are disposed at an interval in a right-left direction of the case 12 and are integrated with an inner surface of a rear wall 16B of the lower case 16 and the inner surface of the bottom plate 16A. The first inclined mount 20A has an inclined surface 20A1, and the inclined surface 20A1 is inclined downward from the inner surface of the rear wall 16B toward the inner surface of the bottom plate 16A. Further, the second inclined mount 20B has an inclined surface 20B1, and the inclined surface 20B1 is also inclined downward from the inner surface of the rear wall 16B toward the inner surface of the bottom plate 16A.

In front of the support member 20, a pair of position restricting ribs 22 are disposed at an interval in the right-left direction. The pair of position restricting ribs 22 are provided upright on the inner surface of the bottom plate 16A and restrict a position of a lower end part of the cartridge memory 19 in a state in which the cartridge memory 19 is disposed on the support member 20.

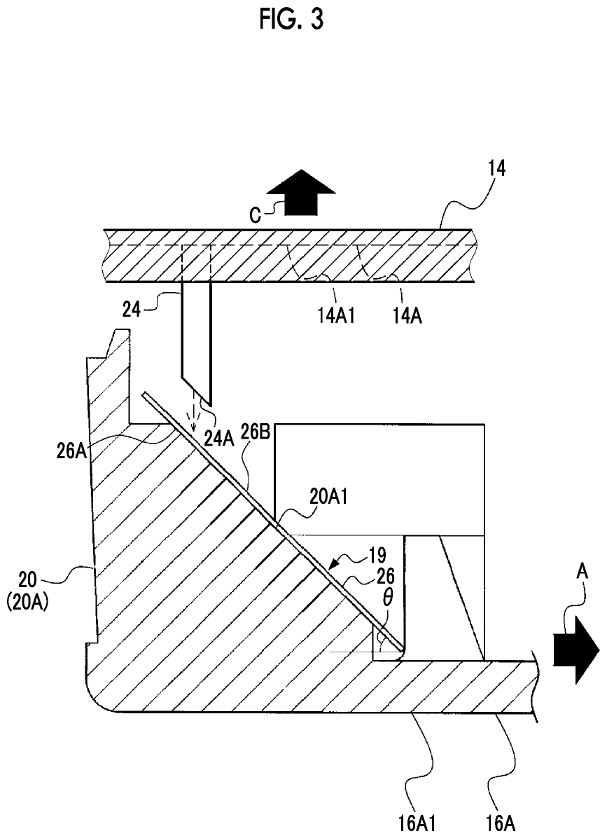

As shown in FIG. 3 as an example, a reference surface 16A1 is formed on an outer surface of the bottom plate 16A. The reference surface 16A1 is a plane. Here, the plane indicates a surface parallel to a horizontal plane in a case where the lower case 16 is placed on the horizontal plane with the bottom plate 16A facing the lower side. Here, “parallel” indicates parallel in a meaning including an error that is generally allowed in the technical field to which the technology of the present disclosure belongs, and an error to such an extent not contrary to the gist of the technology of the present disclosure, in addition to completely parallel. An inclined angle θ of the support member 20, that is, an inclined angle of each of the inclined surface 20A1 and the inclined surface 20B1 (see FIG. 2), is 45 degrees with respect to the reference surface 16A1. The inclined angle of 45 degrees is merely an example, and may be in a range of “0 degrees<inclined angle θ<45 degrees” or may be “45 degrees≤inclined angle θ”.

The cartridge memory 19 comprises a substrate 26. The substrate 26 is placed on the support member 20 with a back surface 26A of the substrate 26 facing the lower side, and the support member 20 supports the back surface 26A of the substrate 26 from below. A part of the back surface 26A of the substrate 26 is in contact with the inclined surface of the support member 20, that is, the inclined surfaces 20A1 and 20B1 (see FIG. 2), and a front surface 26B of the substrate 26 is exposed to an inner surface 14A1 side of a top plate 14A of the upper case 14.

The upper case 14 comprises a plurality of ribs 24. The plurality of ribs 24 are disposed at intervals in the right-left direction of the case 12. The plurality of ribs 24 are provided so as to protrude toward the lower side from the inner surface 14A1 of the top plate 14A of the upper case 14, and a distal end surface 24A of each rib 24 is an inclined surface corresponding to the inclined surfaces 20A1 and 20B1 (see FIG. 2). That is, the distal end surface 24A of each rib 24 is inclined at 45 degrees with respect to the reference surface 16A1.

In a case where the upper case 14 is bonded to the lower case 16 as described above in a state in which the cartridge memory 19 is disposed on the support member 20, the distal end surface 24A of each rib 24 comes into contact with the substrate 26 from the front surface 26B side, and the substrate 26 is pinched between the distal end surface 24A of each rib 24 and the inclined surfaces 20A1 and 20B1 (see FIG. 2) of the support member 20. With this, a position in an up-down direction of the cartridge memory 19 is restricted by the ribs 24.

As shown in FIG. 4 as an example, the magnetic tape drive 30 comprises a transport device 34, a magnetic head 36, and a control device 38. The magnetic tape cartridge 10 is loaded into the magnetic tape drive 30. The magnetic tape drive 30 is a device that pulls out the magnetic tape MT from the magnetic tape cartridge 10, records data on the pulled-out magnetic tape MT by using the magnetic head 36, and reads data from the pulled-out magnetic tape MT by using the magnetic head 36 in a linear serpentine method. In the present embodiment, in other words, reading of data indicates reproduction of data.

The control device 38 controls the operation of the entire magnetic tape drive 30. In the present embodiment, although the control device 38 is realized by an ASIC 120 (see FIG. 14), the technology of the present disclosure is not limited thereto. For example, the control device 38 may be realized by an FPGA. Alternatively, the control device 38 may be realized by a computer including a CPU, a ROM, and a RAM. Alternatively, the control device 38 may be realized by a combination of two or more of the ASIC 120, the FPGA, and the computer. That is, the control device 38 may be realized by a combination of a hardware configuration and a software configuration.

The transport device 34 is a device that selectively transports the magnetic tape MT in a forward direction and a backward direction, and comprises a feeding motor 40, a winding reel 42, a winding motor 44, a plurality of guide rollers GR, and the control device 38.

The feeding motor 40 rotates the cartridge reel 18 provided in the magnetic tape cartridge 10 under the control of the control device 38. The control device 38 controls the feeding motor 40 to control a rotation direction, a rotation speed, rotation torque, and the like of the cartridge reel 18.

In a case where the magnetic tape MT is wound on the winding reel 42, the control device 38 rotates the feeding motor 40 such that the magnetic tape MT runs in the forward direction. A rotation speed, rotation torque, and the like of the feeding motor 40 are adjusted according to a speed of the magnetic tape MT to be wound on the winding reel 42.

The winding motor 44 rotates the winding reel 42 under the control of the control device 38. The control device 38 controls the winding motor 44 to control a rotation direction, a rotation speed, rotation torque, and the like of the winding reel 42.

In a case where the magnetic tape MT is wound on the winding reel 42, the control device 38 rotates the winding motor 44 such that the magnetic tape MT runs in the forward direction. A rotation speed, rotation torque, and the like of the winding motor 44 are adjusted according to the speed of the magnetic tape MT to be wound on the winding reel 42. The rotation speed, the rotation torque, and the like of each of the feeding motor 40 and the winding motor 44 are adjusted in this manner, whereby tension is applied to the magnetic tape MT. That is, the feeding motor 40 and the winding motor 44 are an example of a “tension applying mechanism” according to the technology of the present disclosure.

In a case of rewinding the magnetic tape MT onto the cartridge reel 18, the control device 38 rotates the feeding motor 40 and the winding motor 44 such that the magnetic tape MT runs in the backward direction.

In the present embodiment, the tension applied to the magnetic tape MT is controlled by controlling the rotation speed, the rotation torque, and the like of the feeding motor 40 and the winding motor 44, but the technology of the present disclosure is not limited thereto. For example, the tension applied to the magnetic tape MT may be controlled by using a dancer roller or may be controlled by drawing the magnetic tape MT into a vacuum chamber.

Each of the plurality of guide rollers GR is a roller that guides the magnetic tape MT. A running path of the magnetic tape MT is determined by separately disposing the plurality of guide rollers GR at positions where the plurality of guide rollers GR straddle the magnetic head 36 between the magnetic tape cartridge 10 and the winding reel 42.

The magnetic head 36 comprises a recording and reading element 46 and a holder 48. The recording and reading element 46 is held by the holder 48 so as to come into contact with the running magnetic tape MT, and records data on the magnetic tape MT transported by the transport device 34 and reads data from the magnetic tape MT.

The magnetic tape drive 30 comprises a noncontact reading and writing device 50. The noncontact reading and writing device 50 is disposed below the magnetic tape cartridge 10 so as to directly face the back surface 26A of the substrate 26 of the cartridge memory 19 in a state in which the magnetic tape cartridge 10 is loaded. The state in which the magnetic tape cartridge 10 is loaded in the magnetic tape drive 30 indicates, for example, a state in which the magnetic tape cartridge 10 has reached a position determined in advance as a position where data reading of the magnetic head 36 with respect to the magnetic tape MT starts.

In the example shown in FIG. 4, an aspect example in which the noncontact reading and writing device 50 is mounted on the magnetic tape drive 30 has been described, the technology of the present disclosure is not limited thereto. The noncontact reading and writing device 50 is also used in a stage in which the magnetic tape cartridge 10 is manufactured, a stage in which the magnetic tape cartridge 10 is inspected, or a stage in which the magnetic tape cartridge 10 is shipped. In this case, for example, a stationary or portable noncontact reading and writing device 50 is used. In the following description, only in a case where a distinction is needed, the noncontact reading and writing device 50 mounted on the magnetic tape drive 30 is denoted by the noncontact reading and writing device 50A, and the stationary or portable noncontact reading and writing device 50 that is used in a stage in which the magnetic tape cartridge 10 is manufactured, a stage in which the magnetic tape cartridge 10 is inspected, or a stage in which the magnetic tape cartridge 10 is shipped is denoted by the noncontact reading and writing device 50B.

As shown in FIG. 5 as an example, the noncontact reading and writing device 50A emits the magnetic field MF from below the magnetic tape cartridge 10 toward the cartridge memory 19. The magnetic field MF passes through the cartridge memory 19.

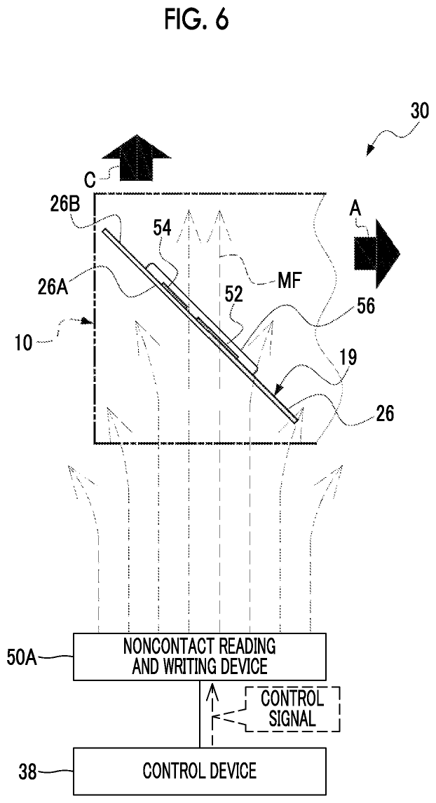

As shown in FIG. 6 as an example, the noncontact reading and writing device 50A is connected to the control device 38. The control device 38 outputs a control signal for controlling the cartridge memory 19 to the noncontact reading and writing device 50A. The noncontact reading and writing device 50A emits the magnetic field MF toward the cartridge memory 19 in accordance with the control signal input from the control device 38. The magnetic field MF passes through the cartridge memory 19 from the back surface 26A side to the front surface 26B side of the substrate 26.

The noncontact reading and writing device 50A gives a command signal corresponding to the control signal to the cartridge memory 19 by performing noncontact communication with the cartridge memory 19. In more detail, the noncontact reading and writing device 50A spatially transmits the command signal to the cartridge memory 19 under the control of the control device 38. Although details will be described later, the command signal is a signal indicating a command with respect to the cartridge memory 19.

Here, an aspect example in which the noncontact reading and writing device 50A spatially transmits the command signal to the cartridge memory 19 under the control of the control device 38 has been described, but the technology of the present disclosure is not limited thereto. The noncontact reading and writing device 50B spatially transmits the command signal to the cartridge memory 19 under the control of a control device different from the control device 38, for example, in a stage in which the magnetic tape cartridge 10 is manufactured, a stage in which the magnetic tape cartridge 10 is inspected, or a stage in which the magnetic tape cartridge 10 is shipped.

The noncontact reading and writing device 50A makes the magnetic field MF include a command signal corresponding to an instruction from the control device 38. In other words, the command signal is superimposed on the magnetic field MF by the noncontact reading and writing device 50A. That is, the noncontact reading and writing device 50A transmits the command signal to the cartridge memory 19 via the magnetic field MF under the control of the control device 38.

An IC chip 52 and a capacitor 54 are mounted on the front surface 26B of the substrate 26 of the cartridge memory 19. The IC chip 52 and the capacitor 54 adhere to the front surface 26B. The IC chip 52 and the capacitor 54 are sealed by a sealing material 56. Here, as the sealing material 56, an ultraviolet curable resin that is cured by reacting with ultraviolet rays is employed. The ultraviolet curable resin is merely an example, and a photocurable resin that is cured by reacting with light in a wavelength range other than ultraviolet rays may be used as the sealing material 56, a thermosetting resin may be used as the sealing material 56, or other adhesives may be used as the sealing material 56.

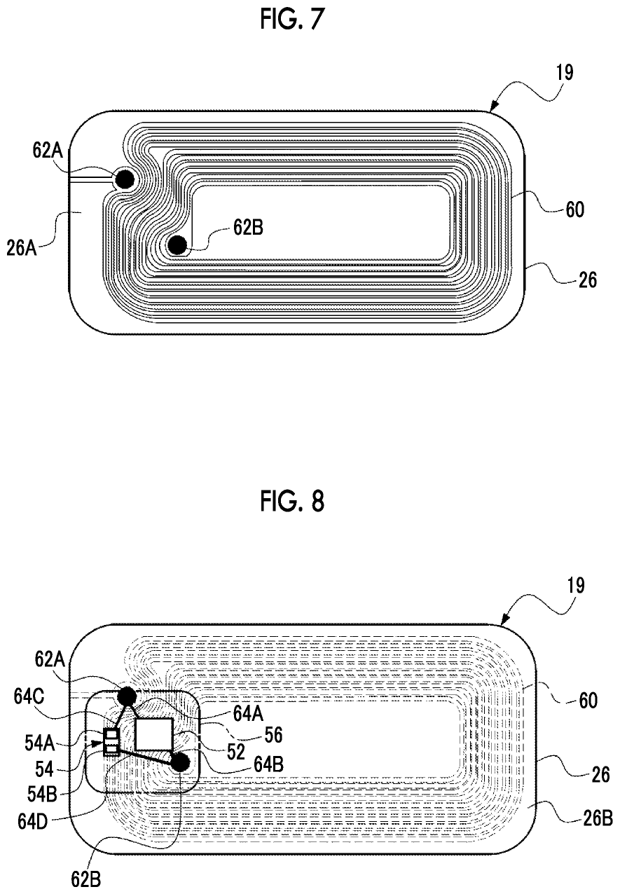

As shown in FIG. 7 as an example, a coil 60 is formed in a loop shape on the back surface 26A of the substrate 26 of the cartridge memory 19. Here, copper foil is employed as a material of the coil 60. The copper foil is merely an example, and, for example, other types of conductive materials, such as aluminum foil, may be used. The coil 60 induces an induced current with the application of the magnetic field MF (see FIGS. 5 and 6) from the noncontact reading and writing device 50.

A first conduction portion 62A and a second conduction portion 62B are provided on the back surface 26A of the substrate 26 of the cartridge memory 19. The first conduction portion 62A and the second conduction portion 62B have solder and electrically connect both end parts of the coil 60 to the IC chip 52 (see FIGS. 6 and 8) and the capacitor 54 (see FIGS. 6 and 8) of the front surface 26B.

As shown in FIG. 8 as an example, on the front surface 26B of the substrate 26 of the cartridge memory 19, the IC chip 52 and the capacitor 54 are electrically connected to each other using a wire connection method. Specifically, one terminal of a positive electrode terminal and a negative electrode terminal of the IC chip 52 is connected to the first conduction portion 62A via a wiring line 64A, and the other terminal is connected to the second conduction portion 62B via a wiring line 64B. Further, the capacitor 54 has a pair of electrodes. In the example shown in FIG. 8, the pair of electrodes are electrodes 54A and 54B. The electrode 54A is connected to the first conduction portion 62A via a wiring line 64C, and the electrode 54B is connected to the second conduction portion 62B via a wiring line 64D. With this, the IC chip 52 and the capacitor 54 are connected in parallel with the coil 60.

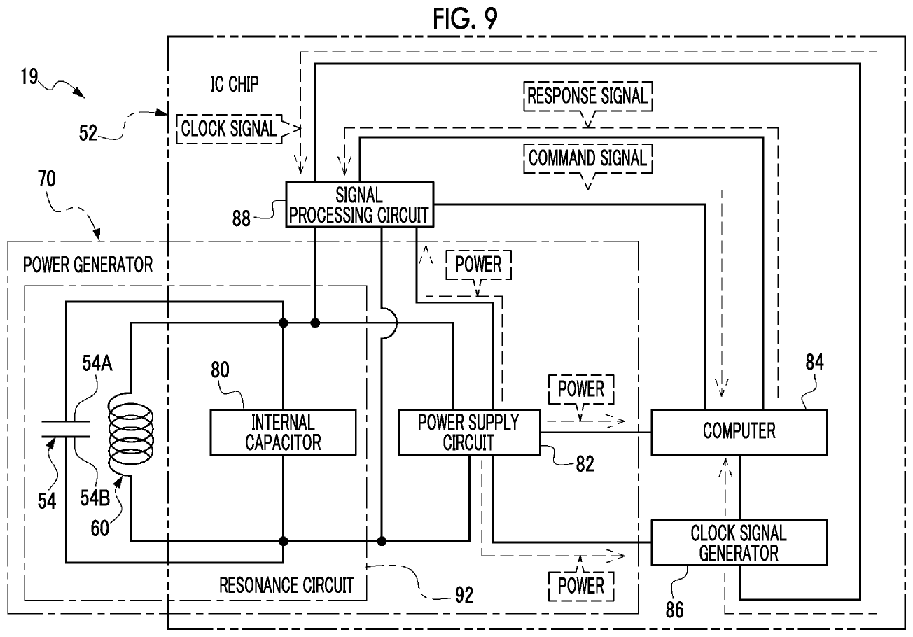

As shown in FIG. 9 as an example, the IC chip 52 comprises an internal capacitor 80, a power supply circuit 82, a computer 84, a clock signal generator 86, and a signal processing circuit 88. The IC chip 52 is a general-purpose IC chip that is usable for applications other than the magnetic tape cartridge 10.

The cartridge memory 19 comprises a power generator 70. The power generator 70 generates power with the application of the magnetic field MF from the noncontact reading and writing device 50 to the coil 60. Specifically, the power generator 70 generates alternating-current power using a resonance circuit 92, and converts the generated alternating-current power into direct-current power to output the direct-current power.

The power generator 70 has the resonance circuit 92 and the power supply circuit 82. The resonance circuit 92 comprises the capacitor 54, the coil 60, and the internal capacitor 80. The internal capacitor 80 is a capacitor incorporated in the IC chip 52, and the power supply circuit 82 is also a circuit incorporated in the IC chip 52. The internal capacitor 80 is connected in parallel with the coil 60.

The capacitor 54 is a capacitor externally attached to the IC chip 52. The IC chip 52 is a general-purpose IC chip that is intrinsically usable for applications different from the magnetic tape cartridge 10. For this reason, the capacitance of the internal capacitor 80 may not be enough to realize a resonance frequency required for the cartridge memory 19 used in the magnetic tape cartridge 10. In that respect, in the cartridge memory 19, the capacitor 54 is post-attached to the IC chip 52 as a capacitor having a capacitance value necessary in causing the resonance circuit 92 to resonate at a predetermined resonance frequency with the application of the magnetic field MF. In a case where the internal capacitor 80 has capacitance enough to realize the resonance frequency required for the cartridge memory 19 used in the magnetic tape cartridge 10, the capacitor 54 is, of course, unnecessary. The predetermined resonance frequency is a frequency (for example, 13.56 MHz) corresponding to a frequency of the magnetic field MF, and need only be appropriately decided on the basis of the specification or the like of the cartridge memory 19 and/or the noncontact reading and writing device 50. Further, the capacitance of the capacitor 54 is determined on the basis of a measured value of the capacitance of the internal capacitor 80.

The resonance circuit 92 generates alternating-current power by generating a resonance phenomenon at the predetermined resonance frequency using the induced current induced by the coil 60 with the magnetic field MF passing through the coil 60. The resonance circuit 92 outputs the generated alternating-current power to the power supply circuit 82.

The power supply circuit 82 has a rectifier circuit, a smoothing circuit, and the like. The rectifier circuit is a full-wave rectifier circuit having a plurality of diodes. The full-wave rectifier circuit is merely an example, and a half-wave rectifier circuit may be used. The smoothing circuit includes a capacitor and a resistor. The power supply circuit 82 converts the alternating-current power input from the resonance circuit 92 into direct-current power and supplies various drive elements provided in the IC chip 52 with the direct-current power (hereinafter, also simply referred to as “power”) obtained by the conversion. Examples of the various drive elements include the computer 84, the clock signal generator 86, and the signal processing circuit 88. In this way, power is supplied to various drive elements provided in the IC chip 52 by the power generator 70, whereby the IC chip 52 operates.

The computer 84 controls the operation of the entire cartridge memory 19. The clock signal generator 86 generates a clock signal and outputs the clock signal to the signal processing circuit 88 and the like. The signal processing circuit 88 and the like operate in accordance with the clock signal input from the clock signal generator 86. The clock signal generator 86 changes a frequency of the clock signal in accordance with an instruction of the computer 84.

The signal processing circuit 88 is connected to the resonance circuit 92. The signal processing circuit 88 has a decoding circuit (not shown) and an encoding circuit (not shown). The decoding circuit of the signal processing circuit 88 extracts and decodes the command signal from the magnetic field MF received by the coil 60 and outputs the command signal to the computer 84. The computer 84 outputs a response signal to the command signal to the signal processing circuit 88. That is, the computer 84 executes processing corresponding to the command signal input from the signal processing circuit 88 and outputs a processing result as the response signal to the signal processing circuit 88. In a case where the response signal is input from the computer 84, the encoding circuit of the signal processing circuit 88 encodes the response signal to modulate the response signal and outputs the response signal to the resonance circuit 92. The resonance circuit 92 transmits the response signal input from the encoding circuit of the signal processing circuit 88 to the noncontact reading and writing device 50 via the magnetic field MF.

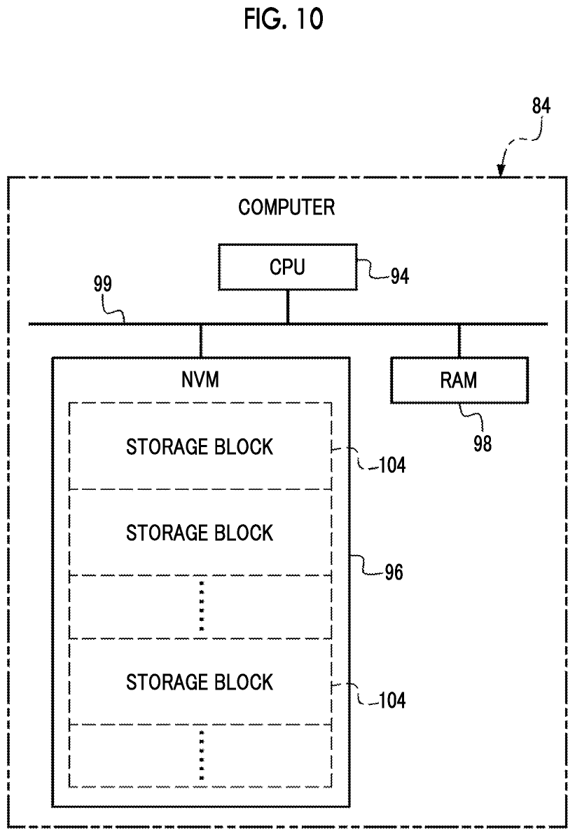

As shown in FIG. 10 as an example, the computer 84 comprises a CPU 94, an NVM 96, and a RAM 98. The CPU 94, the NVM 96, and the RAM 98 are connected to a bus 99.

The CPU 94 controls the operation of the computer 84. The NVM 96 is an example of an “internal storage medium” according to the technology of the present disclosure. An example of the NVM 96 includes an EEPROM. The EEPROM is merely an example, and, for example, a ferroelectric memory may be used instead of the EEPROM or any memory may be used as long as the memory is a non-volatile memory that can be mounted on the IC chip 52. The NVM 96 has a plurality of storage blocks 104. The management information and the like are stored in the plurality of storage blocks 104.

The CPU 94 selectively performs polling processing, read-out processing, write-in processing, locking processing, and the like according to the command signal input from the signal processing circuit 88. The polling processing is processing of establishing communication with the noncontact reading and writing device 50, and is performed, for example, as preparation processing in a pre-stage of the read-out processing and the write-in processing. The read-out processing is processing of reading out the management information and the like from the NVM 96. The write-in processing is processing of writing the management information and the like into the NVM 96. The locking processing is processing of locking the storage block 104, in other words, processing of disabling rewriting of information stored in the storage block 104. Here, a meaning of “rewriting of information” also includes a meaning of “erasure of information”.

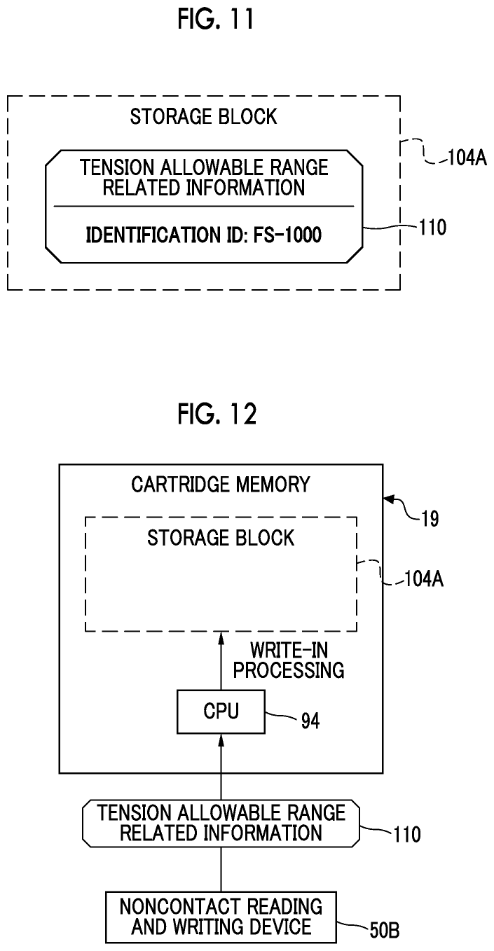

As shown in FIG. 11 as an example, tension allowable range related information 110 is stored in a storage block 104A that is one of the plurality of storage blocks 104. The tension allowable range related information 110 is information regarding the allowable range of tension applied to the magnetic tape MT. Here, the allowable range is a range obtained by, for example, a computer simulation and/or a test with a real machine, as a range of tension at which recording and/or reading of data performed by the magnetic head 36 can be performed without problems.

The tension allowable range related information 110 is an identification ID for uniquely identifying the type of the magnetic tape cartridge 10. The identification ID is, for example, a combination of an alphabet representing a manufacturer of the magnetic tape cartridge 10, such as “FS”, and a numeral representing a serial number or a model number of the magnetic tape cartridge 10, such as “1000”. The identification ID is an example of “identification information” according to the technology of the present disclosure.

As shown in FIG. 12 as an example, the noncontact reading and writing device 50B spatially transmits the tension allowable range related information 110 and a write-in command of the tension allowable range related information 110 as the command signal to the cartridge memory 19 at a timing of any one of a stage in which the magnetic tape cartridge 10 is manufactured, a stage in which the magnetic tape cartridge 10 is inspected, or a stage in which the magnetic tape cartridge 10 is shipped. The CPU 94 performs the write-in processing of storing the tension allowable range related information 110 in the storage block 104A according to the command signal transmitted from the noncontact reading and writing device 50B. With this, the tension allowable range related information 110 is stored in the storage block 104A.

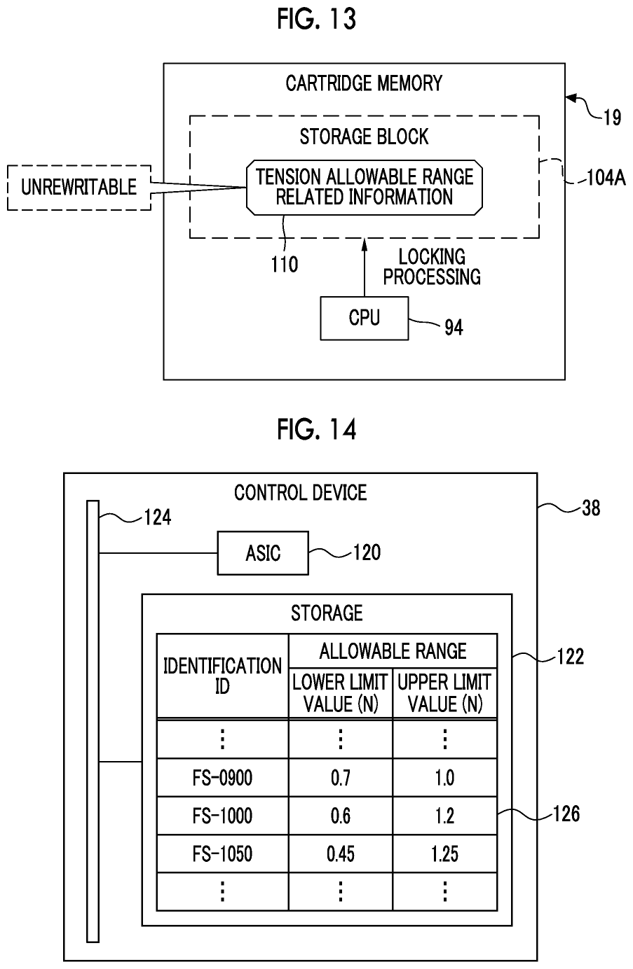

As shown in FIG. 13 as an example, the CPU 94 performs the locking processing on the storage block 104A in which the tension allowable range related information 110 is stored. The locking processing is performed on the storage block 104A in this manner, whereby the tension allowable range related information 110 is unrewritable. That is, the storage block 104A is an example of a “storage block in which information is unrewritable” according to the technology of the present disclosure. The locking processing may be performed immediately after the tension allowable range related information 110 is stored in the storage block 104A or may be performed in a case where the magnetic tape cartridge 10 is initially loaded into the magnetic tape drive 30 and the magnetic tape MT is initialized.

As shown in FIG. 14 as an example, the control device 38 has the ASIC 120 and a storage 122. The ASIC 120 and the storage 122 are connected to a bus 124. The ASIC 120 is an example of a “processor” according to the technology of the present disclosure.

An allowable range table 126 is stored in the storage 122. The allowable range of tension corresponding to the identification ID of the tension allowable range related information 110 is registered in the allowable range table 126. Specifically, the allowable range is upper and lower limit values. The allowable range table 126 is updated each time a new product of the magnetic tape cartridge 10 is released.

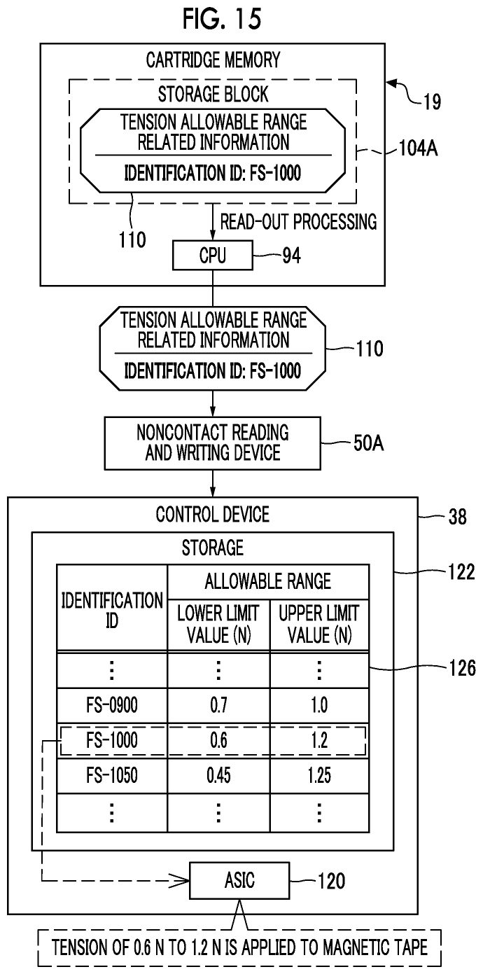

As shown in FIG. 15 as an example, the noncontact reading and writing device 50A spatially transmits a read-out command of the tension allowable range related information 110 as the command signal to the cartridge memory 19 at a timing at which the magnetic tape cartridge 10 is loaded into the magnetic tape drive 30. The CPU 94 performs the read-out processing of reading out the tension allowable range related information 110 from the storage block 104A according to the command signal transmitted from the noncontact reading and writing device 50A. Then, the CPU 94 spatially transmits the read-out tension allowable range related information 110 as the response signal to the noncontact reading and writing device 50A. The noncontact reading and writing device 50A is an example of a “read-out device” according to the technology of the present disclosure. Further, the noncontact reading and writing device 50A, the magnetic tape cartridge 10, the control device 38, and the like constitute a magnetic tape system 51 (see FIG. 4).

The noncontact reading and writing device 50A outputs the tension allowable range related information 110 from the cartridge memory 19 to the control device 38. The ASIC 120 of the control device 38 reads out the allowable range corresponding to the identification ID of the tension allowable range related information 110 from the allowable range table 126. The ASIC 120 controls the operations of the feeding motor 40 and the winding motor 44 to apply tension within the read-out allowable range to the magnetic tape MT.

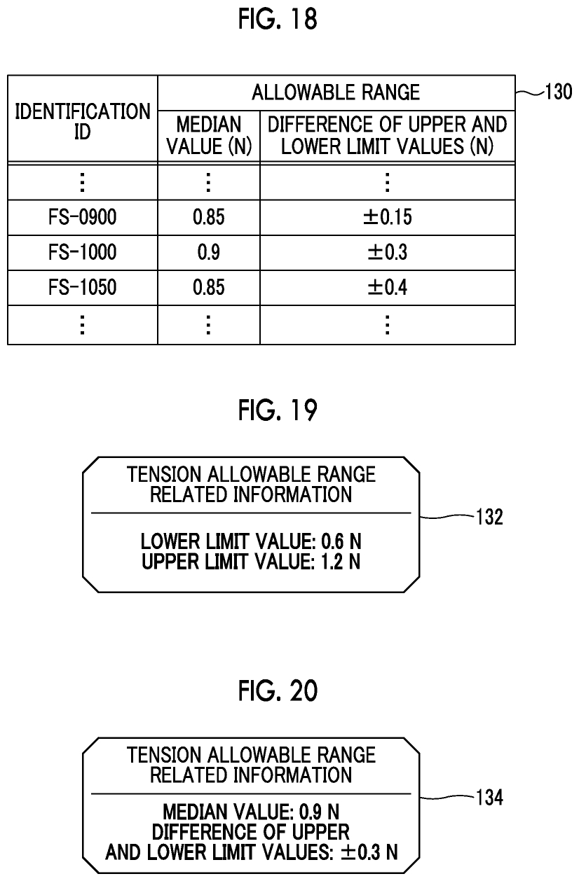

FIG. 15 illustrates a case where “FS-1000” is stored in the identification ID of the tension allowable range related information 110. In this case, the ASIC 120 reads out “0.6 N and 1.2 N” as the upper and lower limit values of the allowable range corresponding to the identification ID “FS-1000” from the allowable range table 126. Then, the ASIC 120 controls the operations of the feeding motor 40 and the winding motor 44 to apply tension within “0.6 N to 1.2 N” to the magnetic tape MT. The ASIC 120 applies, for example, tension having a median value of the allowable range (see FIG. 18 and the like), tension of 0.9 N in this example, to the magnetic tape MT. In FIG. 15, the bus 124 is not shown.

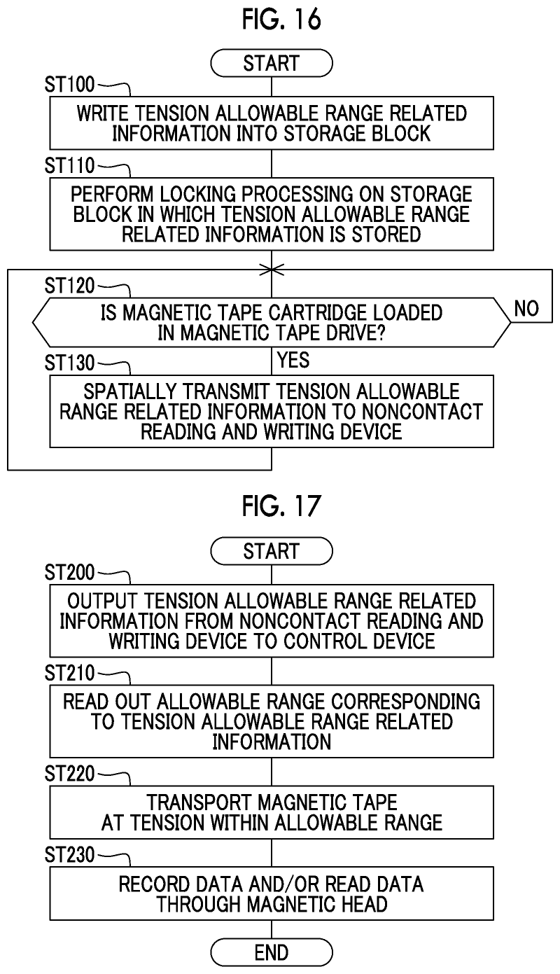

Next, the actions of the above-described configuration will be described with reference to flowcharts of FIGS. 16 and 17. First, as shown in FIG. 16 as an example, as shown in FIG. 12, the CPU 94 writes the tension allowable range related information 110 from the noncontact reading and writing device 50B into the storage block 104A of the cartridge memory 19 at a timing of any one of a stage in which the magnetic tape cartridge 10 is manufactured, a stage in which the magnetic tape cartridge 10 is inspected, or a stage in which the magnetic tape cartridge 10 is shipped (Step ST100). Next, as shown in FIG. 13, the CPU 94 performs the locking processing on the storage block 104A in which the tension allowable range related information 110 is stored (Step ST110). With this, the tension allowable range related information 110 is unrewritable.

At a timing at which the magnetic tape cartridge 10 is loaded into the magnetic tape drive 30 (YES in Step ST120), as shown in FIG. 15, the CPU 94 reads out the tension allowable range related information 110 from the storage block 104A. Then, the CPU 94 spatially transmits the tension allowable range related information 110 to the noncontact reading and writing device 50A (Step ST130).

As shown in FIG. 17 as an example, the tension allowable range related information 110 is output from the noncontact reading and writing device 50A to the control device 38 as shown in FIG. 15 (Step ST200). Subsequently, the ASIC 120 reads out the allowable range corresponding to the identification ID of the tension allowable range related information 110 from the allowable range table 126 (Step ST210). Then, under the control of the ASIC 120, the feeding motor 40 and the winding motor 44 are rotated, and the magnetic tape MT is transported in the forward direction or the backward direction. At this time, the ASIC 120 controls the operations of the feeding motor 40 and the winding motor 44, and tension within the allowable range is applied to the magnetic tape MT (Step ST220).

Under the control of the ASIC 120, the magnetic head 36 is operated, and data is recorded onto the running magnetic tape MT and/or data recorded on the running magnetic tape MT is read (Step ST230).

As described above, the magnetic tape cartridge 10 comprises the case 12 in which the magnetic tape MT is accommodated, and the NVM 96 of the cartridge memory 19 provided in the case 12. The NVM 96 stores the tension allowable range related information 110 regarding the allowable range of the tension applied to the magnetic tape MT. Accordingly, it is possible to obtain information regarding the allowable range of the tension applied to the magnetic tape MT.

As shown in FIG. 11, the tension allowable range related information 110 is the identification ID. As shown in FIG. 14, the identification ID corresponds to the upper and lower limit values of the allowable range. Therefore, confidentiality of the allowable range can be enhanced as compared with a case where the upper and lower limit values of the allowable range itself are stored in the NVM 96 as the tension allowable range related information 110.

In the present embodiment, the NVM 96 is used as the storage medium. The NVM 96 is incorporated in the cartridge memory 19 where reading-out and writing-in of information are performed by the noncontact reading and writing device 50. Therefore, the reading-out and the writing-in of the tension allowable range related information 110 can be easily performed.

The tension allowable range related information 110 is stored in the storage block 104A in which the information is unrewritable. Therefore, it is possible to prevent inadvertent rewriting or erasing of the tension allowable range related information 110.

The magnetic tape drive 30 in which the magnetic tape cartridge 10 is loaded comprises the feeding motor 40 and the winding motor 44, and the ASIC 120 that controls the operations of the feeding motor 40 and the winding motor 44 to apply tension within the allowable range represented by the tension allowable range related information 110 to the magnetic tape MT. Therefore, there is no concern that tension exceeding the upper limit value of the allowable range may be applied to the magnetic tape MT and irreversible damage, such as plastic deformation, may be given to the magnetic tape MT. Further, there is no concern that tension below the lower limit value of the allowable range may be applied to the magnetic tape MT and the running magnetic tape MT may be flapped. Accordingly, it is possible to stably perform recording of data onto the magnetic tape MT and/or reading of data recorded on the magnetic tape MT.

The allowable range table 126 in which the upper and lower limit values of the allowable range corresponding to the identification ID of the tension allowable range related information 110 are registered has been illustrated, but the technology of the present disclosure is not limited thereto. An allowable range table 130 shown in FIG. 18 as an example may be used. In the allowable range table 130, a pair of a difference and a median value of the allowable range corresponding to the identification ID of the tension allowable range related information 110 are registered. The difference is a difference of the upper and lower limit values of the allowable range with respect to the median value. The ASIC 120 can grasp the allowable range of the tension applied to the magnetic tape MT, even with the allowable range table 130.

The tension allowable range related information 110 is not limited to the illustrated identification ID. As in tension allowable range related information 132 shown in FIG. 19 as an example, the upper and lower limit values of the allowable range may be used. Alternatively, as in tension allowable range related information 134 shown in FIG. 20 as an example, a pair of the median value of the allowable range and the difference of the upper and lower limit values of the allowable range with respect to the median value may be used. With the tension allowable range related information 132 and 134, it is not necessary to prepare the allowable range table 126 or 130 in the storage 122 of the control device 38.

### Second Embodiment

In the above-described first embodiment, the NVM 96 of the cartridge memory 19 is illustrated as the storage medium, but the technology of the present disclosure is not limited thereto.

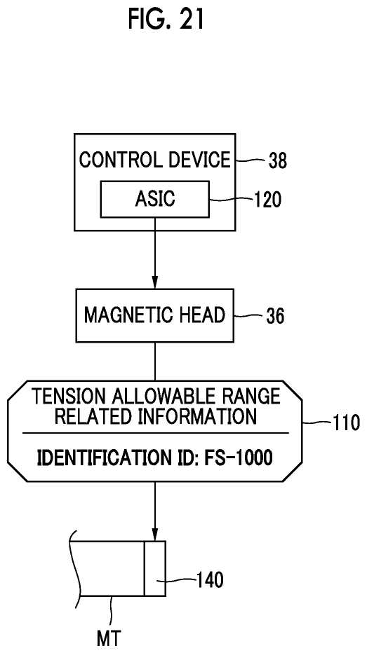

As shown in FIG. 21 as an example, at a timing of any one of a case where the magnetic tape cartridge 10 is initially loaded or a case where the magnetic tape MT is initialized, the ASIC 120 of the control device 38 controls the operation of the magnetic head 36 to write the tension allowable range related information 110 into a BOT region 140 provided at the head of the magnetic tape MT. Further, although not shown, the ASIC 120 controls the operation of the magnetic head 36 to read the tension allowable range related information 110 from the BOT region 140. In this case, the tension allowable range related information 110 is input by a user, for example, via an operation input unit (not shown). The BOT region 140 is an example of a “region of a part of the magnetic tape” according to the technology of the present disclosure.

In this way, in the second embodiment, the BOT region 140 of the magnetic tape MT is used as the storage medium. Therefore, it is possible to save labor to prepare the cartridge memory 19 or labor to store the tension allowable range related information 110 in the storage block 104A.

The tension allowable range related information 110 may be stored in the BOT region 140 by a magnetic head of a magnetic tape drive disposed in a factory at a timing of any one of a stage in which the magnetic tape cartridge 10 is manufactured, a stage in which the magnetic tape cartridge 10 is inspected, or a stage in which the magnetic tape cartridge 10 is shipped.

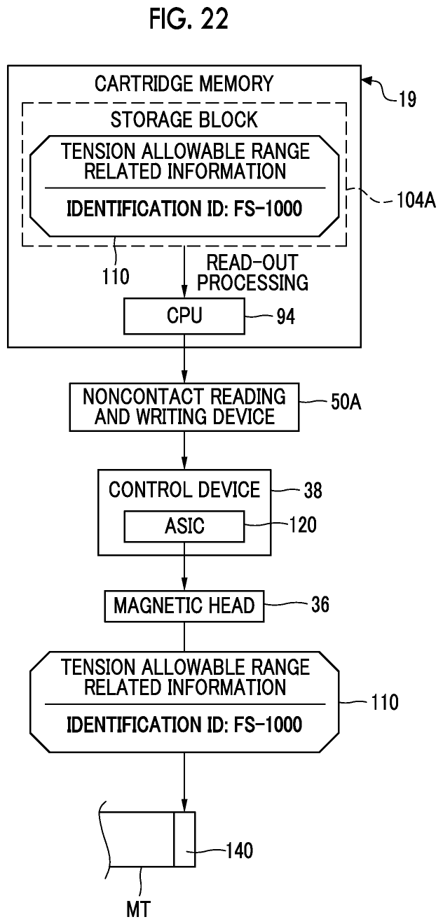

Further, as shown in FIG. 22 as an example, an aspect may be employed in which the tension allowable range related information 110 read out from the cartridge memory 19 by the noncontact reading and writing device 50A is written into the BOT region 140 by the ASIC 120. In this case, the tension allowable range related information 110 is stored in both the storage block 104A and the BOT region 140. Therefore, the tension allowable range related information 110 stored in the storage block 104A and the tension allowable range related information 110 stored in the BOT region 140 can be matched with each other, and the reliability of the tension allowable range related information 110 can be verified. Further, even though a failure occurs in any one of the storage block 104A or the BOT region 140, it is possible to obtain the tension allowable range related information 110 from the other. Instead of or in addition to the BOT region 140, the tension allowable range related information 110 may be stored in an EOT region (not shown) provided at the tail of the magnetic tape MT.

The technology of the present disclosure is not limited to the illustrated aspect in which the cartridge memory 19 is incorporated in the case 12. The cartridge memory 19 may be attached to an outer surface of the case 12.

The identification information is not limited to the illustrated identification ID. A product name itself of the magnetic tape cartridge 10 may be used as the identification information. Further, the storage medium is not limited to the illustrated NVM 96 of the cartridge memory 19 and the BOT region 140 of the magnetic tape MT. For example, a two-dimensional barcode or the like may be used as the storage medium.

As the hardware resource that executes the processing of the control device 38, various processors described below can be used. Examples of the processors include a CPU which is a general-purpose processor functioning as a hardware resource that executes software, that is, a program, to execute the processing. Further, examples of the processors include a dedicated electric circuit which is a processor having a dedicated circuit configuration designed for executing specific processing, such as an FPGA, a PLD, or the illustrated ASIC 120. A memory is also incorporated in or connected to any processor, and any processor uses the memory to execute the processing.

The hardware resource that executes the processing of the control device 38 may be composed of one of various processors or may be composed of a combination of two or more processors of the same type or different types (for example, a combination of a plurality of FPGAs or a combination of a CPU and an FPGA). Alternatively, the hardware resource that executes the processing of the control device 38 may be one processor.

A first example in which the hardware resource is composed of one processor is an aspect in which one or more CPUs and software are combined to constitute one processor and the processor functions as the hardware resource that executes the processing. A second example is an aspect in which a processor that realizes the functions of the entire system including a plurality of hardware resources that execute the processing with one IC chip is used, as typified by an SoC or the like. In this way, the processing of the control device 38 is realized using one or more of various processors as the hardware resource.

Furthermore, as the hardware structures of various processors, more specifically, an electric circuit into which circuit elements, such as semiconductor elements, are combined can be used. Further, the processing of the control device 38 described above is merely an example. Accordingly, it goes without saying that unnecessary steps may be deleted, new steps may be added, or a processing order may be changed without departing from the gist.

Similarly, in regard to the cartridge memory 19, instead of or in addition to the illustrated CPU 94, a dedicated electric circuit which is a processor having a dedicated circuit configuration designed for executing specific processing, such as an FPGA, a PLD, or an ASIC, may be used.

The technology of the present disclosure can also appropriately combine the above-mentioned various embodiments and/or various modification examples. In addition, it goes without saying that the technology of the present disclosure is not limited to the above embodiments and various configurations may be employed without departing from the gist. Furthermore, in addition to the program, the technology of the present disclosure extends to a storage medium that stores the program in a non-transitory manner.

The content of the above description and the content of the drawings are detailed description of parts according to the technology of the present disclosure, and are merely an example of the technology of the present disclosure. For example, the above description related to configurations, functions, actions, and advantageous effects is description related to an example of the configurations, functions, actions, and advantageous effects of the parts according to the technology of the present disclosure. Accordingly, it is needless to say that unnecessary parts may be deleted, new elements may be added, or replacement may be made to the content of the above description and the content of the drawings without departing from the gist of the technology of the present disclosure. Further, in order to avoid confusion and to facilitate understanding of the parts according to the technology of the present disclosure, description related to common technical knowledge and the like that does not require particular description to enable implementation of the technology of the present disclosure is omitted from the content of the above description and the content of the drawings.

In the present specification, “A and/or B” has the same meaning as “at least one of A or B”. That is, “A and/or B” means that only A may be used, only B may be used, or a combination of A and B may be used. In addition, in the present specification, the same concept as “A and/or B” is also applied to a case where three or more matters are expressed by “and/or”.

All documents, patent applications, and technical standards described in the present specification are incorporated in the present specification by reference to the same extent as in a case where the individual documents, patent applications, and technical standards were specifically and individually stated to be incorporated by reference.

What is claimed is:

1. A magnetic tape cartridge comprising:
a case in which a magnetic tape is accommodated; and
a storage medium provided in the case,
wherein the storage medium stores tension allowable range related information regarding an allowable range of tension applied to the magnetic tape.

2. The magnetic tape cartridge according to claim 1,
wherein the tension allowable range related information is regarding the allowable range of tension applied to the magnetic tape during data recording and/or reading operations.

3. The magnetic tape cartridge according to claim 1,
wherein the tension allowable range related information is identification information corresponding to any one of upper and lower limit values of the allowable range or a pair of a median value of the allowable range and a difference of the upper and lower limit values of the allowable range with respect to the median value.

4. The magnetic tape cartridge according to claim 1,
wherein the tension allowable range related information is any one of upper and lower limit values of the allowable range or a pair of a median value of the allowable range and a difference of the upper and lower limit values of the allowable range with respect to the median value.

5. The magnetic tape cartridge according to claim 1,
wherein the storage medium includes an internal storage medium incorporated in a noncontact communication medium where reading-out and writing-in of information are performed by a noncontact reading and writing device.

6. The magnetic tape cartridge according to claim 5,
wherein the tension allowable range related information is stored in a storage block in which information is unrewritable, the storage block being provided in the internal storage medium.

7. The magnetic tape cartridge according to claim 1,
wherein the storage medium includes a region of a part of the magnetic tape.

8. A magnetic tape drive in which the magnetic tape cartridge according to claim 1 is loaded, the magnetic tape drive comprising:
a tension applying mechanism; and
a processor that controls an operation of the tension applying mechanism to apply tension within the allowable range represented by the tension allowable range related information to the magnetic tape.

9. A method of operating a magnetic tape drive, comprising:
reading out the tension allowable range related information stored in the storage medium provided in the magnetic tape cartridge according to claim 1; and
controlling an operation of a tension applying mechanism to apply tension within the allowable range represented by the read-out tension allowable range related information to the magnetic tape.

10. A magnetic tape system comprising:
the magnetic tape cartridge according to claim 1;
a read-out device that reads out the tension allowable range related information stored in the storage medium; and
a control device that controls an operation of a tension applying mechanism to apply tension within the allowable range represented by the read-out tension allowable range related information to the magnetic tape.
